(19) United States
(12) Patent Application Publication
(10) Pub. No.: US 2019/0281903 A1
(43) Pub. Date: Sep. 19, 2019

(54) INTELLIGENT ACTIVE THERMAL HEATING SYSTEM FOR CLOTHING

(71) Applicant: Ministry of Supply, Inc., Boston, MA (US)

(72) Inventors: Gihan S. Amarasiriwardena, Cambridge, MA (US); Aman A. Advani, Boston, MA (US); Jarlath Mellett, Roswell, GA (US); Sherri Brendenberg-Hostage, Westborough, MA (US); Brian Kennedy, Brookline, MA (US); Geraldo Aldarondo, Boston, MA (US); Luke M. Mooney, Cambridge, MA (US); Jean-François Duval, Boston, MA (US)

(21) Appl. No.: 16/280,184

(22) Filed: Feb. 20, 2019

Related U.S. Application Data
(60) Provisional application No. 62/632,858, filed on Feb. 20, 2018.

(51) Int. Cl. A41D 13/005; H05B 1/02; H05B 3/34; A43B 7/04

(52) U.S. Cl. CPC A41D 13/0051; H05B 1/0272; H05B 3/342; A43B 7/04; A41D 2400/10; H05B 2203/036; A41D 2500/10; A41D 2500/20; H05B 2203/014; H05B 2203/002

(57) ABSTRACT

Apparatus, systems, and methods are described for a heating system incorporated into a garment. An example garment includes: a heating element disposed proximate an internal surface of the garment; a temperature sensor configured to measure a temperature outside of the garment; a motion sensor configured to measure movement of the garment; and a controller configured to adjust power to the heating element based on signals received from the temperature sensor and the motion sensor.

### CROSS-REFERENCE TO RELATED APPLICATIONS

This application claims the benefit of U.S. Provisional Patent Application No. 62/632,858, filed on Feb. 20, 2018, the entire contents of which are incorporated by reference herein.

### TECHNICAL FIELD

The present invention relates generally to outwear and, more particularly, to outerwear that includes a heating system configured to maintain a comfortable temperature during use.

### BACKGROUND

Existing market options for outerwear and thermal management fall within a variety of categories. With traditional outerwear, wearers can choose sleek jackets that are not warm enough or heavy parkas that are suited for only the coldest days of the year and are generally not good for travel. Another option involves layering, in which multiple layers provide thermal insulation and protection from rain and wind. This option, however, can require periodic self-regulation and/or adjustment of layers and generally takes longer for the wearer to get dressed. Accordingly, what is needed is an outerwear garment that can react to wearer preferences, environments, and activity to provide optimal thermal comfort.

### SUMMARY OF THE INVENTION

In general, in one aspect, the subject matter of this disclosure relates to a garment. The garment includes: at least one heating element disposed proximate an internal surface of the garment; a temperature sensor configured to measure a temperature outside of the garment; a motion sensor configured to measure movement of the garment; and a controller configured to adjust power to the at least one heating element based on signals received from the temperature sensor and the motion sensor.

In certain examples, the at least one heating element is or includes a resistive heating element. The at least one heating element can include a first heating element disposed proximate a back side of the garment and a second heating element disposed proximate a front side of the garment. The garment can be or include a jacket, a shirt, a hat, footwear, and/or pants. The temperature sensor can be disposed proximate an exterior surface of the garment. The motion sensor can be or include an accelerometer disposed on or in the garment.

In some implementations, the garment includes a humidity sensor disposed proximate the internal surface of the garment, and the controller can be configured to adjust the power based on a signal received from the humidity sensor. The garment can include a second temperature sensor disposed proximate the internal surface. The controller can be configured to control a temperature inside the garment based on a signal received from the second temperature sensor. The controller can be configured to adjust the power based on at least one heating preference of a wearer of the garment.

In another aspect, the subject matter of this disclosure relates to a method of heating a garment. The method includes: measuring a temperature outside of the garment using a temperature sensor; measuring movement of the garment using a motion sensor; receiving signals from the temperature sensor and the motion sensor; and adjusting power to at least one heating element disposed proximate an internal surface of the garment, based on the received signals.

In certain implementations, the garment is or includes a jacket, a shirt, a hat, footwear, and/or pants. The temperature sensor can be disposed proximate an exterior surface of the garment. The motion sensor can be or include an accelerometer disposed on the garment. The power can be adjusted based on a signal received from a humidity sensor disposed proximate the internal surface of the garment. Adjusting the power can include using a controller configured for at least one of proportional control, derivative control, integral control, or any combination thereof. The method can include: measuring a temperature inside the garment using a second temperature sensor disposed proximate the internal surface; receiving a signal from the second temperature sensor; and controlling the temperature inside the garment based on the signal received from the second temperature sensor.

In another aspect, the subject matter of this disclosure relates to a method of manufacturing a garment. The method includes: providing at least one fabric material having an internal surface of the garment and an external surface of the garment; attaching at least one heating element to the at least one fabric material proximate the internal surface; attaching a temperature sensor to the at least one fabric material proximate the external surface; attaching a motion sensor and a controller to the at least one fabric material; and connecting the at least one heating element, the temperature sensor, and the motion sensor to the controller. The controller is configured to adjust power to the at least one heating element based on signals received from the temperature sensor and/or the motion sensor. In one example, the at least one heating element, the temperature sensor, and/or the motion sensor can be connected to the controller using a plurality of wires. A garment is manufactured according to the method.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1A is a schematic view of a back internal layout of a heating system for a garment, in accordance with certain examples of this disclosure.

FIG. 1B is a schematic view of a front internal layout of a heating system for a garment, in accordance with certain examples of this disclosure

FIG. 2A is a schematic front view a heating system for a garment, in accordance with certain examples of this disclosure.

FIG. 2B is a schematic rear view of a heating system for a garment, in accordance with certain examples of this disclosure.

FIG. 3 is a plot of power versus external temperature for a garment heating system, in accordance with certain examples of this disclosure.

FIG. 4A is a plot of an activity multiplier versus activity level for a garment heating system, in accordance with certain examples of this disclosure.

FIG. 4B is a plot of power versus external temperature based on saved user set points for a garment heating system, in accordance with certain examples of this disclosure.

FIG. 4C is a table of power values for various combinations of external temperature and activity level for a garment heating system, in accordance with certain examples of this disclosure.

FIG. 5 is a schematic diagram of data and hardware interfaces for a garment heating system, in accordance with certain examples of this disclosure.

FIG. 6 is a schematic diagram of electronic hardware, sensors, a controller, and a client device for a garment heating system, in accordance with certain examples of this disclosure.

FIG. 7 is a plot of relative humidity and power versus time for a garment heating system, in accordance with certain examples of this disclosure.

FIGS. 8A and 8B include schematic plots of power versus time for two different users of a garment heating system, in accordance with certain examples of this disclosure.

FIG. 9 is a schematic data flow diagram for a voice command system used to control a garment heating system, in accordance with certain examples of this disclosure.

FIGS. 10A, 10B, and 10C include example screenshots of a graphical user interface for using and controlling a garment heating system, in accordance with certain examples of this disclosure.

FIG. 11A is a schematic diagram of a layout of a garment heating system, in accordance with certain examples of this disclosure.

FIG. 11B is a schematic diagram of electronic components for a garment heating system, in accordance with certain examples of this disclosure.

FIG. 11C is a schematic diagram of electronic components for a garment heating system, in accordance with certain examples of this disclosure.

FIG. 12 is a flowchart of an example method of heating a garment.

FIG. 13 is a flowchart of an example method of manufacturing a garment.

### DETAILED DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

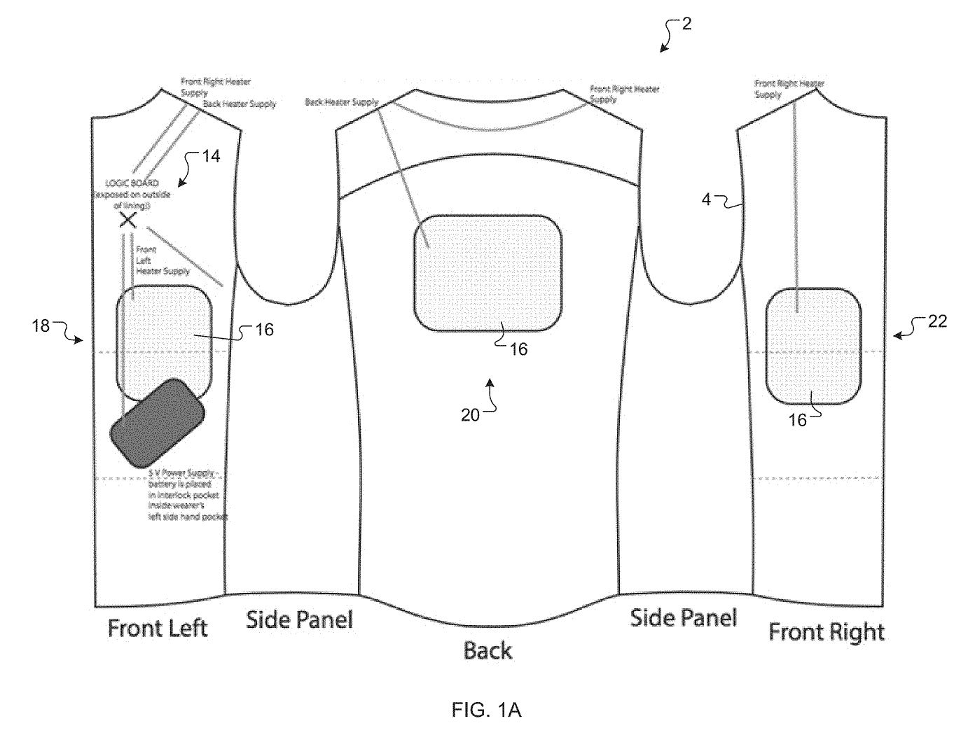

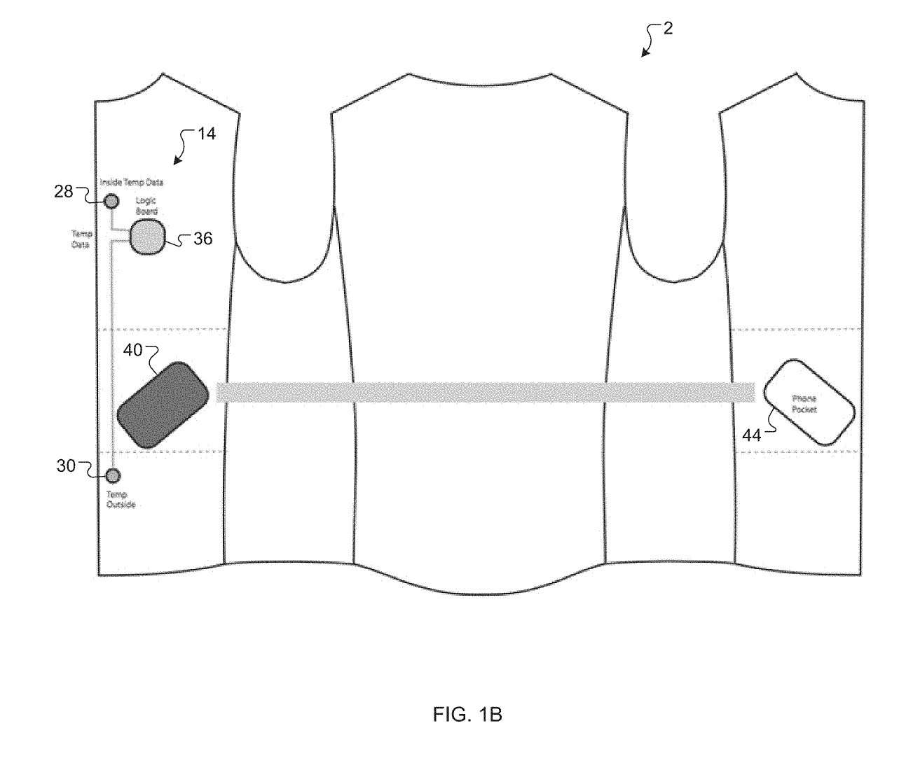

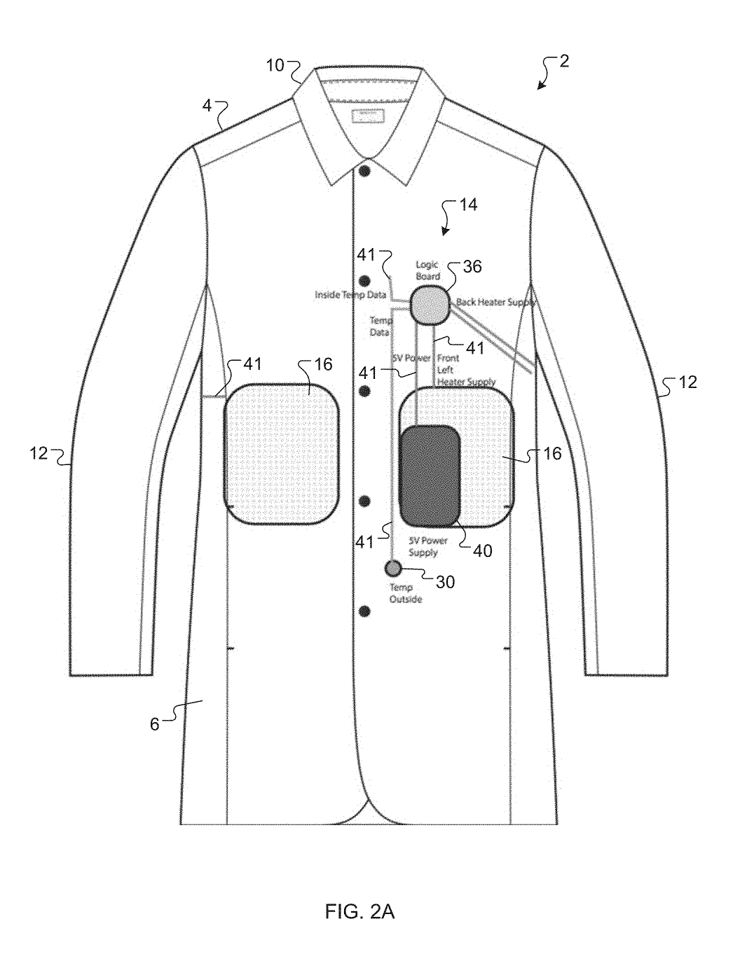

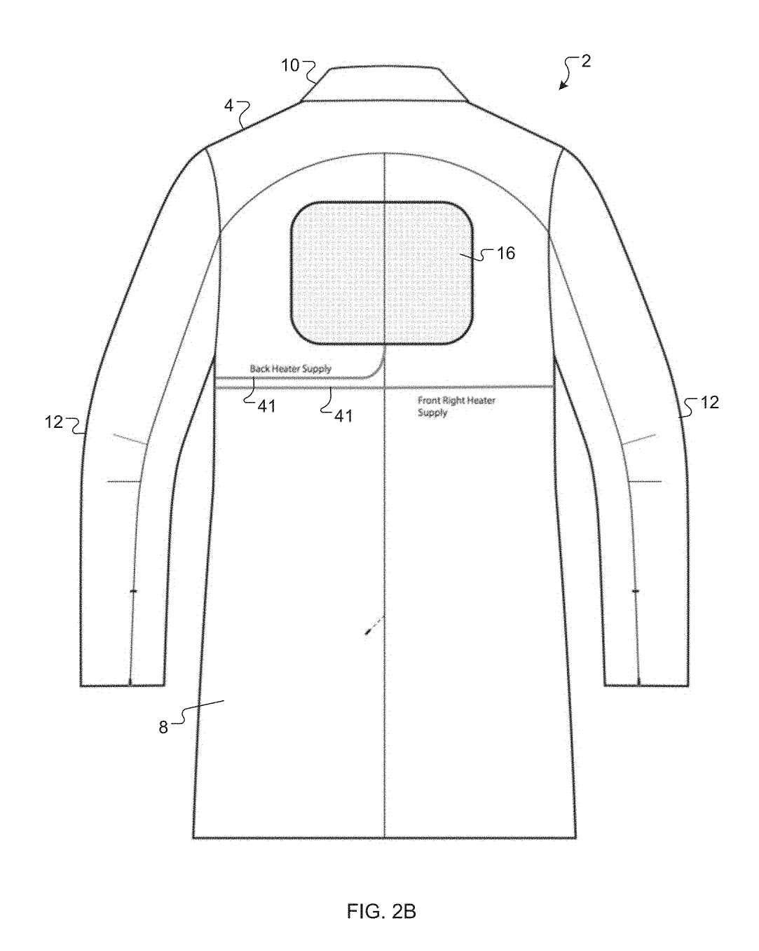

In certain examples, the apparatus, systems, and methods described herein relate to a garment that includes one or more heating elements and a control system for adjusting power to the heating elements. Referring to FIGS. 1A, 1B, 2A, and 2B, for example, a garment 2 can include a fabric structure 4 having one or more layers, including, for example, an outer fabric layer, an insulation layer, and/or an inner lining fabric layer. The outer fabric layer can provide protection from wind, rain, snow, and other elements. The outer fabric layer can be or include, for example, a stretch, synthetic woven and/or knit material, preferably having a semi-permeable, laminated membrane. The insulation layer is generally configured to trap air and can be made of natural materials (e.g., down or wool) and/or synthetic materials, such as, for example, fibrous synthetic non-woven materials (e.g., synthetic fiber batting). The inner lining fabric layer can provide user comfort and/or can contain the insulation layer. The inner lining fabric layer can be or include, for example, a synthetic stretch material. The garment 2 can include a front side 6 and a back side 8. When the garment 2 is a shirt or a jacket, the garment 2 can include a collar 10 and/or sleeves 12.

A heating system 14 for the garment 2 can include one or more heating elements 16, which can be or include, for example, resistive heating elements made of stainless steel, carbon fiber, or other suitable materials. The heating elements 16 can be sandwiched between two layers of a heat-conductive material or fabric, to create a confined heating zone. The heating elements 16 can be sewn or adhered to the inner lining fabric layer of the garment 2 and are preferably not visible from outside of the garment 2. In some examples, the heating elements 16 can be knit or woven into the fabric structure 4.

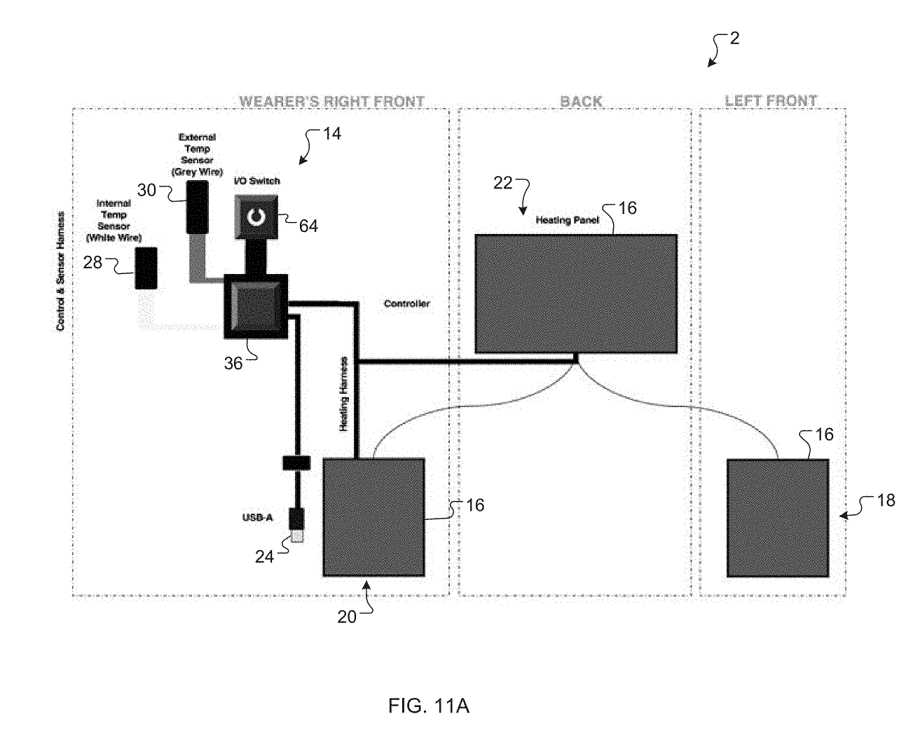

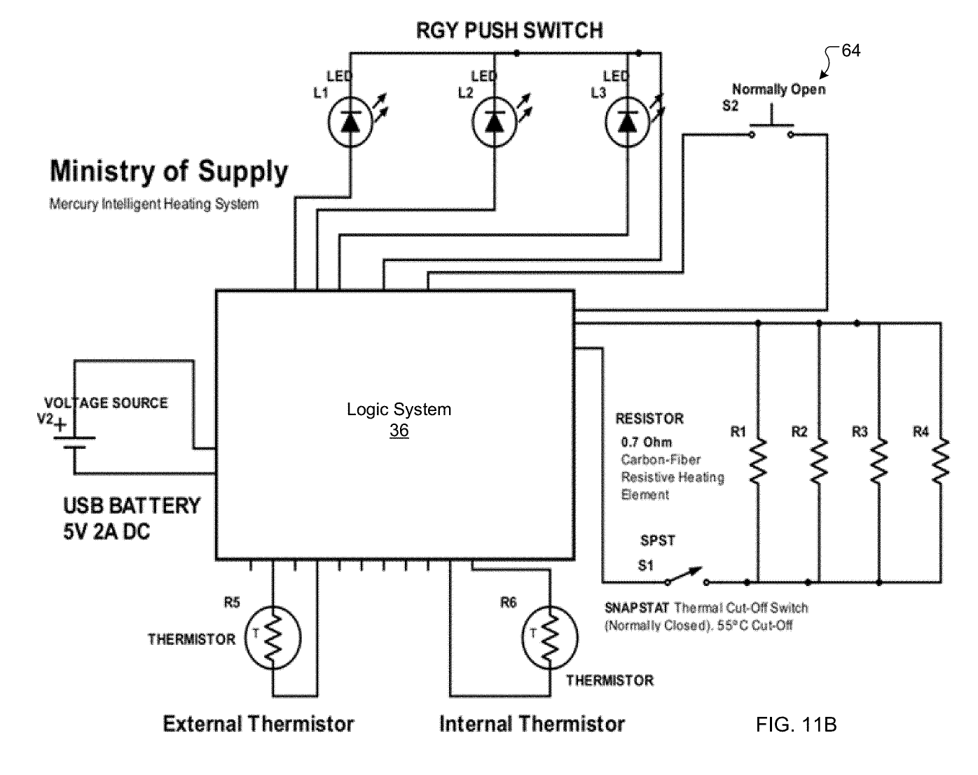

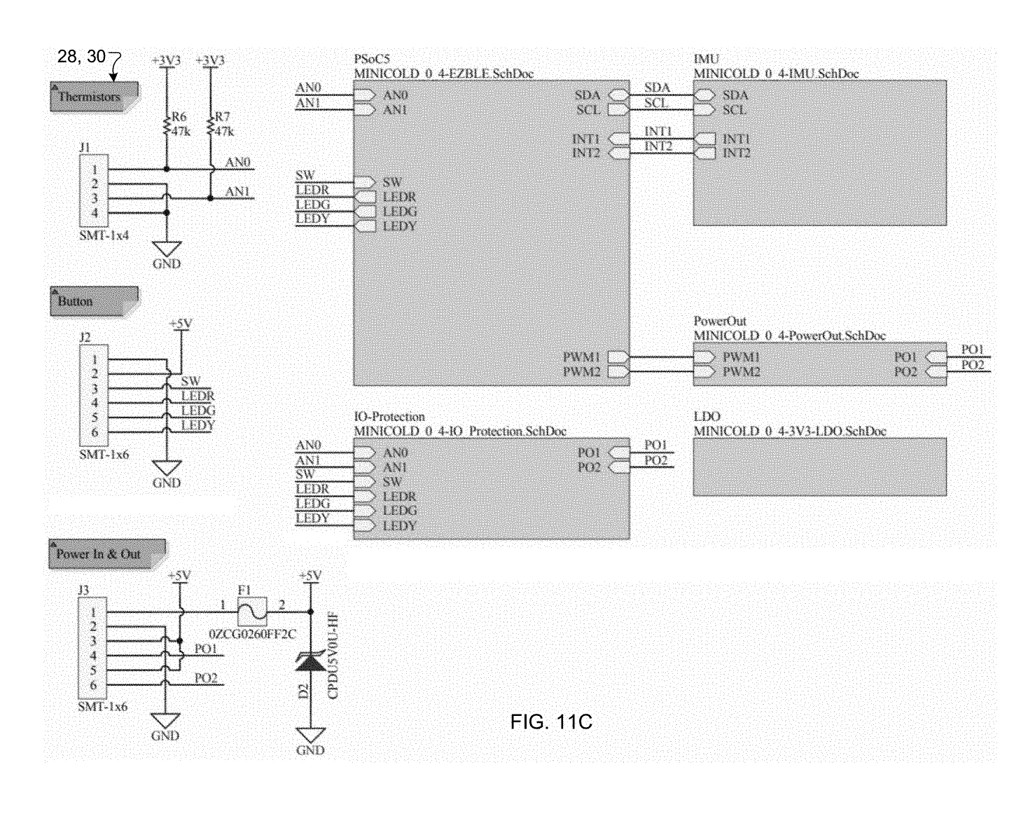

The garment 2 can have heating elements 16 in multiple heating zones, including, for example, a front left region 18, a front right region 20, and/or a back region 22 of the garment 2. The heating elements 16 in the front left region 18 and/or the front right region 20 can be positioned at or near the wearer's chest and/or abdomen. The heating element 16 in the back region 22 can be positioned at, near, or below the wearer's shoulder blades or mid to lower back. Each heating element 16 can be any shape, such as circular, triangular, square, or rectangular. Each heating element 16 can have a heating area (on one side) from about 1 square inch to about 100 square inches. For example, the heating area can be approximately 1, 5, 10, 20, 50, or 100 square inches. The heating elements 16 can be powered by a variety of connectors, including, for example, USB 5-volt connections 24, as depicted in FIG. 11A.

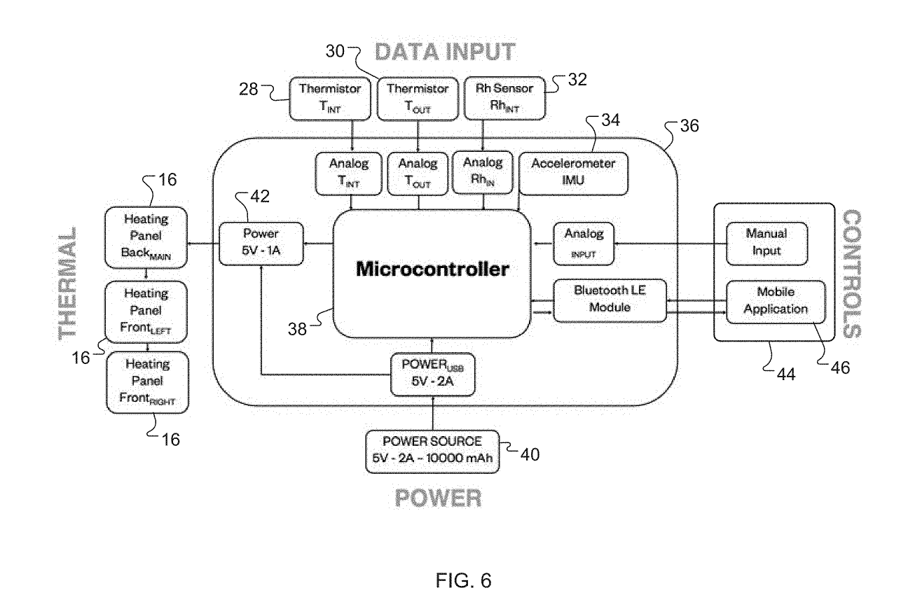

Referring to FIGS. 1B, 2A, 2B, 6, 11A, and 11C, in various examples, the heating system 14 is or includes a control system that utilizes one or more sensors for measuring temperature, humidity, and/or motion in or around the garment 2. The heating system 14 can include, for example, an internal temperature sensor 28 for measuring a temperature inside the garment 2 and/or a temperature of the wearer (also referred to herein as the “user”) and an external temperature sensor 30 for measuring a temperature outside the garment 2. The internal temperature sensor 28 and/or the external temperature sensor 30 can be or include, for example, a solid-state thermistor or thermocouple. One or more humidity sensors 32 can be utilized for measuring relative humidity inside and/or outside of the garment 2. One or more solid-state inertia measuring units (IMUs) 34 can be utilized for measuring motion in or around the garment 2 (e.g., in the sleeves 12, front side 6, or back side 8). Each IMU 34 can be or include an accelerometer and/or a gyroscope. The one or more sensors (e.g., the IMU 34) can be placed directly on or can be connected to a controller or logic system 36, which can include, for example, one or more system-on-chip microprocessors or microcontrollers 38. In preferred examples, the one or more sensors provide digital and/or analog signals to the logic system 36. The logic system 36 can process the signals and/or use the signals to regulate power to the heating elements 16 from a battery source 40, which can be or include, for example, one or more lithium-chemistry batteries or other suitable batteries (e.g., 5V). One or more solid-state power electronic switches 42, such as metal-oxide-semiconductor field-effect transistors (MOSFETS), can be used to control and regulate power to the heating elements 16. Components for the heating system 14 can be connected with one or more wires 41, which are preferably positioned between two layers of fabric and/or secured to a fabric layer (e.g., the inner lining fabric layer) in the garment 2. Wireless connectivity between the logic system 36 and a client device 44 (e.g., a mobile phone) of the wearer can be provided, for example, via BLUETOOTH and/or WiFi protocols.

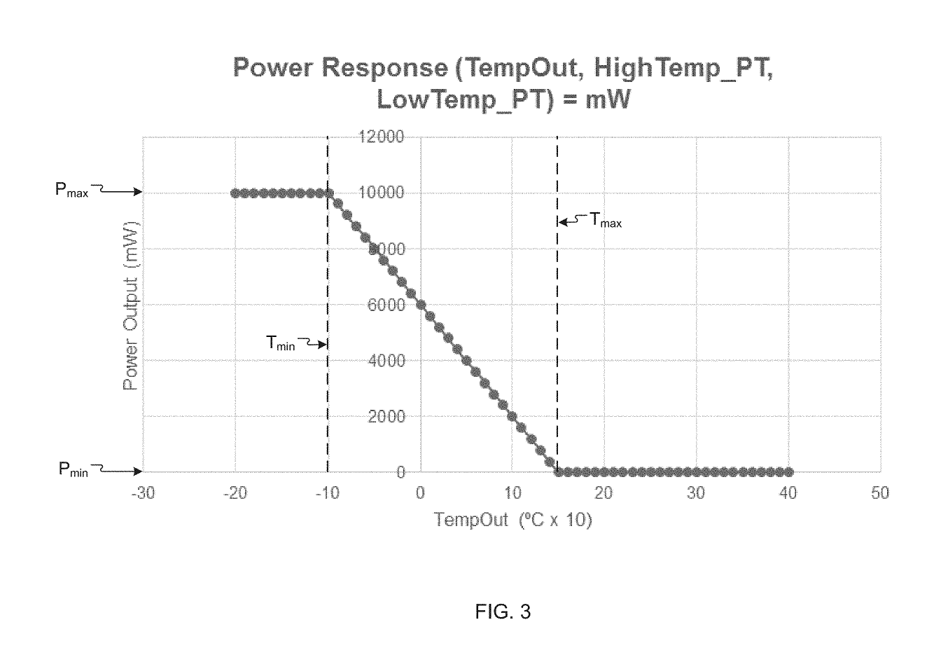

Control logic for the heating system 14 may run on a remote server, a mobile application 46 (e.g., on the client device 44), and/or on the logic system 36. In preferred examples, the control logic can use machine learning algorithms to correlate user preferences to power output, based on environmental conditions and/or wearer activity. Using, for example, linear, quadratic, exponential, or other regression models, the control logic can generate a control function to determine an ideal power output for the user, as depicted in FIGS. 3, 4A, 4B, 4C and 7. In some implementations, the user can provide preferred heat or power settings, which can be saved along with corresponding external temperatures, internal temperatures, and/or activity levels. In one model, the external temperature and desired power setting pairs can be saved, and a least-squares, linear regression can be performed to generate a desired relationship between power and external temperature. The relationship can be or include, for example, a power-external temperature response polynomial function, linear function, exponential function, or other desired functional form.

Additionally or alternatively, relative humidity and desired power setting pairs can be saved, and a least-squares, linear regression performed to generate a desired relationship between power and relative humidity. The relationship can be or include, for example, a power-humidity level response model in the form of a polynomial function, linear function, exponential function, or other desired functional form. In some examples, a mathematical relationship between power and multiple input parameters (e.g., external temperature, internal temperature, relative humidity, and/or user activity) can be developed and used to determine a suitable power based on the input parameters.

In one example, a normalized multiplier can be generated from a linear activity-power response curve that is multiplied by the external-temperature power response function to create a composite power-response. The power-activity multiplier can be inversely proportional to humidity level such that as the relative humidity between the garment and the wearer's body rises, indicating perspiration, power can be reduced.

In various examples, activity level can be determined by a three-dimensional magnitude summation of acceleration vectors, as measured using the IMU 34 (e.g., in x, y and z directions). The vector summation can be, for example, a Pythagorean or Euclidean distance, given by

Aₛᵤₘ\sqrt{Aₓ²+A_{y}²+A_{z}²}, (1)

where Aₛᵤₘ is the vector summation or absolute magnitude of acceleration, Aₓ is acceleration in the x-direction (relative to an orientation of the IMU 34), A_{y} is acceleration in the y-direction, and A_{z} is acceleration in the z-direction. The vector summation can reduce signal sensitivity to specific orientations of the garment and/or the IMU 34 with respect to the garment. Activity level and desired power setting pairs can be saved, and a least-squares regression performed to generate a power-activity level response model in the form of a polynomial function, a linear function, a piecewise linear function, and/or an exponential function. Other functional forms can be used. The logic system 36 can be configured to discern types of activity of the wearer based on a variance of acceleration. For example, rapid, repeated movements or accelerations can indicate the wearer is running, while slow, intermittent movements can indicate the wearer is standing or sitting still. A leaky integral can be used as a summation of (i) an acceleration value from a previous cycle or movement (e.g., a step) plus (ii) an acceleration value from a current cycle or movement, with a leak factor subtracted. This can allow for an aggregate recent activity level to be determined, from which power can be modulated or adjusted (e.g., using a proportional-integral or other control scheme). Alternatively or additionally, a low-pass filter can be used to determine activity level based on acceleration vectors. In some instances, for example, an average activity level can be computed for a recent window of time (e.g., a previous second, 10 seconds, or 1 minute), based on the acceleration vectors. Measured activity level can be used to calculate an activity multiplier, as described herein, which can be used to adjust power to the garment.

Various degrees of activity level can be computed between low activity (e.g., sitting) and high activity (e.g., intense running), based on signals from the IMU 34. During periods of high activity, the logic system 36 can reduce power to prevent overheating and/or reduce unnecessary power usage. Likewise, the logic system 36 can increase power during periods of low activity and/or to provide pre-emptive heating. In some instances, a normalized multiplier (e.g., the activity multiplier) can be generated from a linear activity-power response curve that is multiplied by the external-temperature response function to create a composite power-response. The power-activity multiplier can be inversely proportional to activity level, such that a wearer who is standing at rest can have full heat applied while a wearer who is walking can have less heat applied (lower power), due to a correlation between metabolic thermal output and activity.

Advantageously, activity level measurements can provide an accurate prediction of the wearer's future metabolic heat output and corresponding need for garment heating. Consideration of activity level can provide better thermal comfort for the wearer, for example, compared to other approaches that may consider only temperature readings (e.g., temperature inside the garment). Such temperature readings can be poor predictors of the wearer's metabolic heat output. For example, there can be a considerable time lag (e.g., several minutes) between the initiation of physical activity and a subsequent detection of temperature rise inside the garment. This time lag can make it difficult to control power based on temperature measurements alone. By the time the temperature rise is detected and power is reduced, for example, too much power may have been applied and the wearer may have overheated.

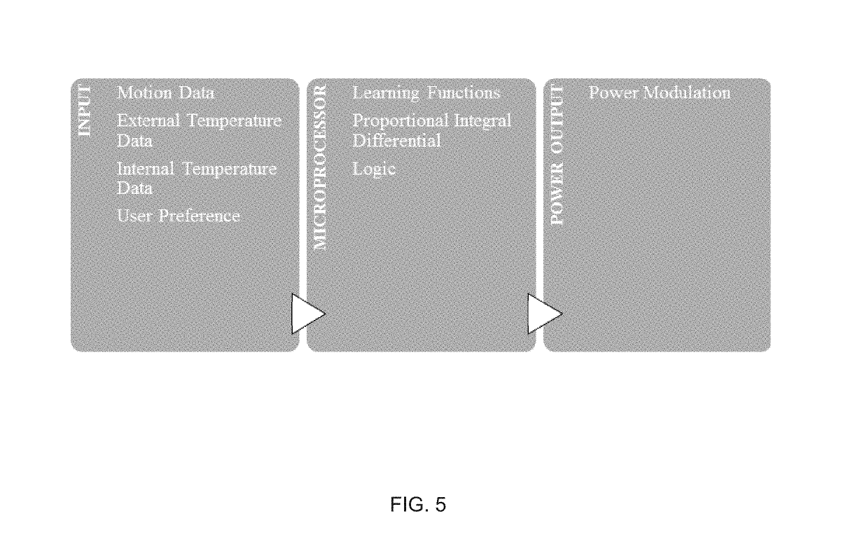

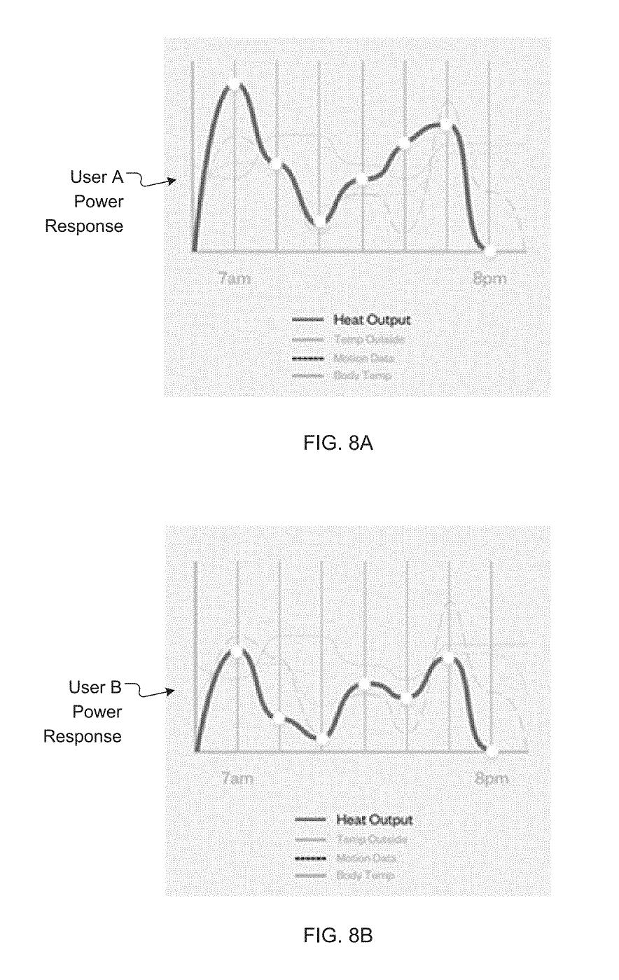

In certain implementations, the mathematical equations or models relating power output to the input parameters (e.g., external temperature, internal temperature, relative humidity, and/or activity level) can be used by the logic system 36 to control the internal temperature inside the garment 2. For example, referring to FIG. 5, the logic system 36 can use one or more models for control a loop, which may include or utilize, for example, proportional control, proportional-integral control, and/or proportional-integral-differential control. In some instances, for example, the logic system can determine a sensitivity or gain between power and one or more measured values (e.g., internal and/or external temperature) and can use the determined sensitivity to adjust power and/or control the internal temperature inside the garment 2. The control function and power response models can be individualized based on user preferences, as shown in FIGS. 8A and 8B.

In some instances, the control logic can use signals from the IMU 34 to determine whether the wearer is standing, walking, running, or not wearing the garment 2. For example, when no movements are detected for more than a threshold period of time (e.g., 1 minute or 5 minutes), the logic system 36 can determine that the garment 2 is not being worn and, in response, can turn off the power to the heating elements 16. Additionally or alternatively, the logic system 36 can determine whether the garment is being worn based measured differences between internal and external temperatures (e.g., using the internal temperature sensor 28 and the external temperature sensor 30). When the internal and external temperatures are identical or similar (e.g., within 1 or 2° C.), the logic system 36 can conclude that the garment is not being worn. Such a determination can be based on this temperature comparison and/or based on measured activity levels.

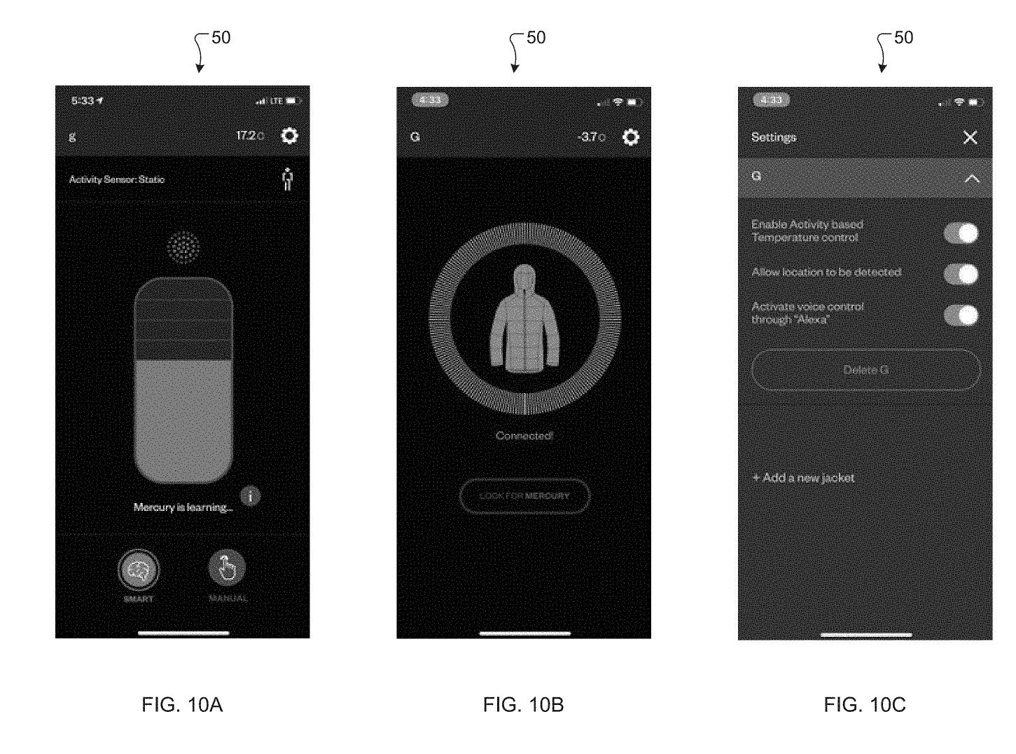

Referring to FIGS. 10A, 10B, and 10C, in preferred implementations, the software application 46 on the client device 44 can include a graphical user interface 50 that presents information related to the heating system 14, including measurement data and/or user preferences. The client device 44 can communication with the heating system 14 (e.g., the logic system 36) using, for example, BLUETOOTH or WiFi protocols. In preferred implementations, the software application 46 can allow for user input related to the user's preferred power settings. The graphical user interface 50 can be or include, for example, a continuous or discrete and/or linear or rotary interface that allows power level to be displayed and/or controlled. The software application 46 can process input data and sensor data as described herein. Additionally or alternatively, the software application 46 can obtain local weather information by connecting to an Internet-based weather service. The local weather information can be or include, for example, an outside temperature, humidity, and/or dewpoint in the vicinity of the garment 2. Such local weather information can be used by the logic system 36 to adjust power to the heating elements 16. In some instances, for example, the local weather information can be used by the logic system 36 to determine an appropriate amount of power to apply for pre-heating the garment, while the garment 2 is indoors and/or before the wearer goes outside. These control functions can be used to improve the predictive response of the heating system 14.

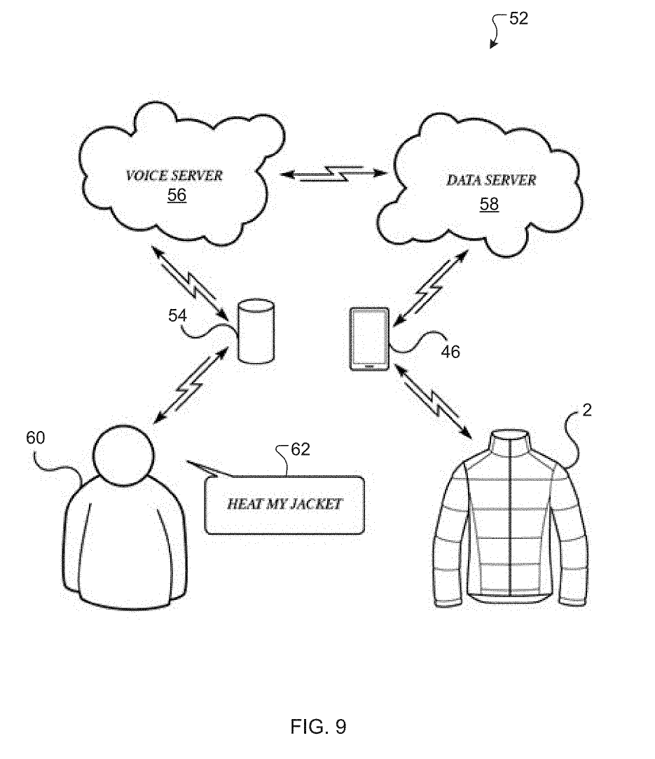

In various implementations, the software application 46 on the client device 44 includes a voice interface that allows the wearer of the garment 2 to control the heating system. For example, voice commands can be used to initiate heating or pre-heating, provide input regarding wearer preferences, and/or modulate or adjust heating power. Referring to FIG. 9, a voice command system 52 can include a voice control device 54, a voice server 56, a data server 58, the software application 46, and the garment 2. A wearer 60 of the garment 2 can issue a voice command 62, such as “heat my jacket.” The voice command 62 can be received by the voice control device 54 (e.g., a microphone) and relayed to the voice server 56. The voice control device 54 and/or the voice server 56 can include voice recognition software for converting the voice command 60 to a text message or other format. The voice command 60 can then be sent to the data server 58, which can store and/or process the voice command. The data server 58 can send the voice command 60 and/or a signal associated with the voice command 60 to the software application 46, which can control temperature inside the garment 2, as described herein. The garment 2 (e.g., using the logic system 36) can send a signal to the software application 46, the data server 58, and/or the voice server 56, confirming that the garment 2 has taken action in response to the voice command 60. In alternative implementations, the voice command 60 can be sent from the voice control device 54 directly to the software application 46 for processing, such that the voice server 56 and/or the data server 58 can be bypassed.

Referring to FIGS. 11A, 11B, and 11C, the heating system 14 can include a button 64 that the wearer can activate to turn the heating system 14 on and off. In general, the wearer may want to turn the heating system off when the garment 2 is not being worn and/or when heating is not desired (e.g., due to warm weather or high wearer activity).

In various examples, the logic system 36 can determine appropriate power levels based on measurements of the external temperature (e.g., from the external temperature sensor 30) and/or wearer activity (e.g., from the IMU 34). For example, FIG. 3 includes a plot of power versus external temperature in which the power P is at a maximum (Pₘₐₓ) (e.g., 10,000 mW) when the external temperature is at or below a minimum temperature Tₘᵢₙ and the power P is at a minimum (Pₘᵢₙ) (e.g., 0 mW) when the external temperature is at or above a maximum temperature Tₘₐₓ. Tₘᵢₙ and Tₘₐₓ in this example are −10° C. and 15° C., respectively. In the depicted example, the power P varies linearly with temperature between Tₘᵢₙ and Tₘₐₓ; however, other mathematical relationships between the power P and external temperature are possible (e.g., exponential or quadratic). The logic system 36 can use the relationship between the power P and external temperature to determine how much power P to provide to the heating elements 16. For example, when the external temperature is 0° C. in this example, the logic system 36 can set the power P to 6,000 mW.

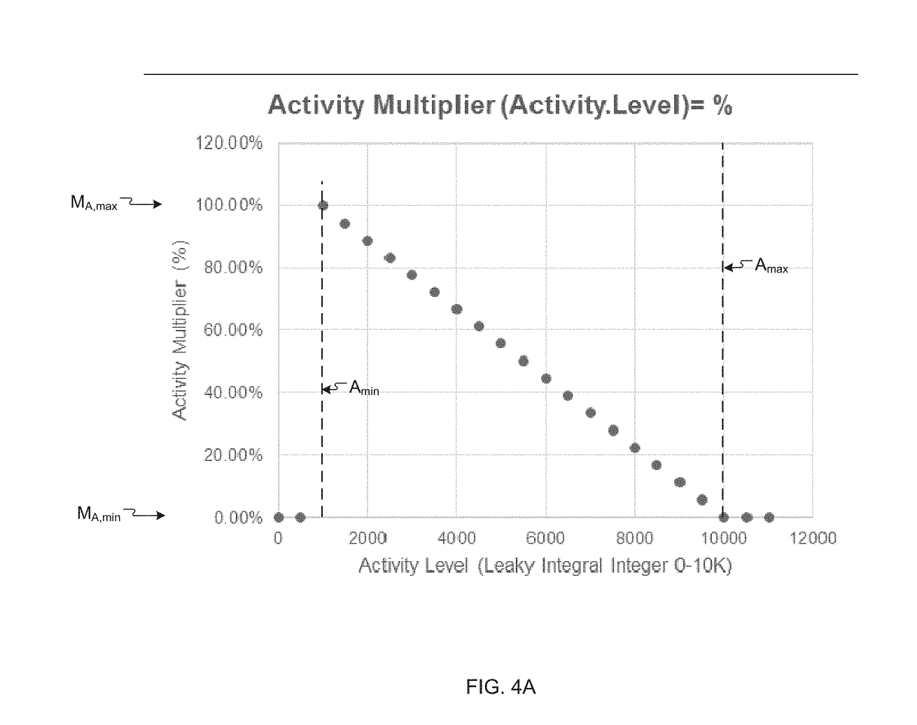

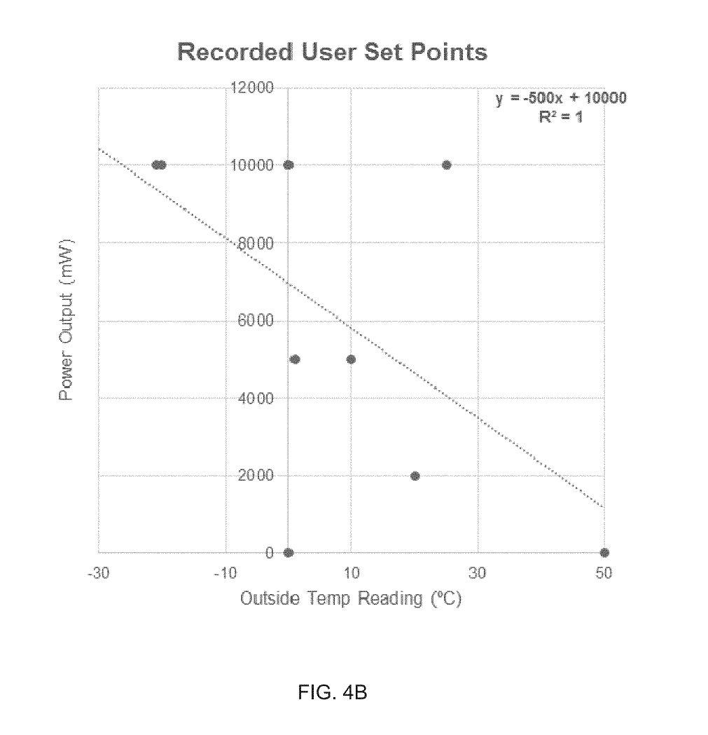

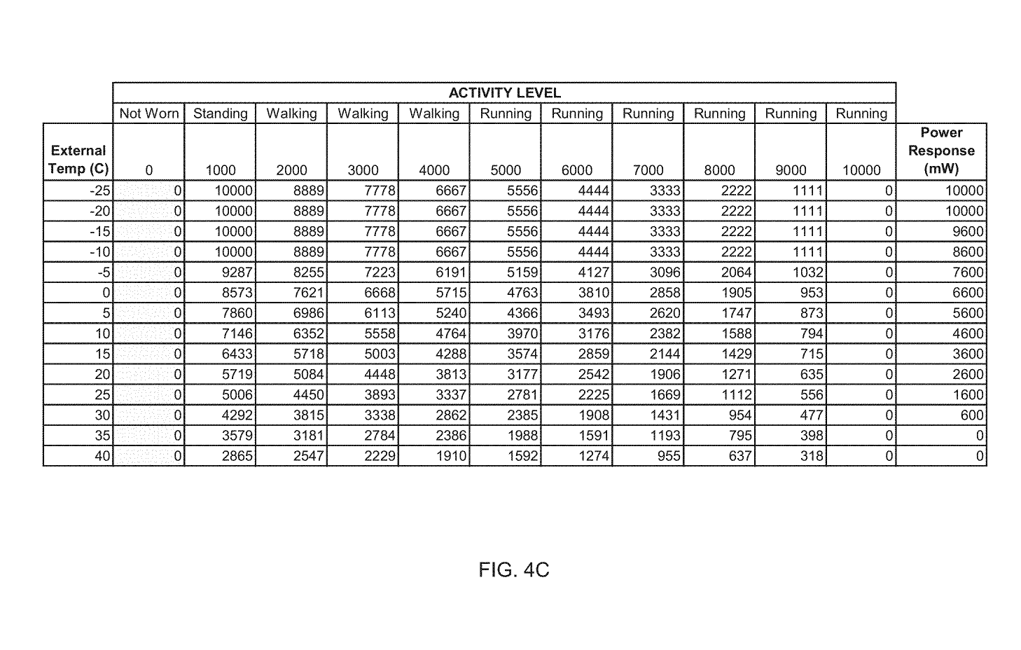

In preferred implementations, values for Tₘᵢₙ, Tₘₐₓ, Pₘᵢₙ, and/or Pₘₐₓ can vary from garment to garment and/or can be determined based on user preferences, user settings, and/or machine learning. Referring to FIG. 4B, for example, a wearer of the garment can use the software application 46 to record or set desired power levels for various external temperatures. Based on these settings, the logic system 36 can determine a custom relationship between power P and external temperature for the wearer. This can be determined, for example, by fitting a line or other functional form through the power and external temperature values provided by the wearer. The logic system 36 can use the custom relationship to determine appropriate power levels, based on measured external temperatures.

Additionally or alternatively, the logic system 36 can determine how much power P to provide to the heating elements 16 based on measured activity levels. In some instances, for example, a measured activity level can be converted to an activity multiplier M_{A} that is used to adjust the power P. For example, FIG. 4A includes a plot of the activity multiplier M_{A} versus activity level in which the activity multiplier M_{A} is at a maximum (M_{A,max}) (e.g., 100% or 1) when the activity level is at a minimum activity level Aₘᵢₙ and the activity multiplier M_{A} is at a minimum (M_{A,min}) (e.g., 0% or 0) when the activity level is at or above a maximum activity level Aₘₐₓ. Aₘᵢₙ and Aₘₐₓ in this example are 1,000 and 10,000, respectively. Aₘᵢₙ can correspond to minimal physical activity, such as sitting or standing. Activity levels below Aₘᵢₙ can indicate, for example, that the garment is not being worn. Accordingly, the activity multiplier M_{A} can be set to M_{A,min} when the activity level is below Aₘᵢₙ, to avoid unnecessary power consumption. Aₘₐₓ can correspond to intense physical activity, such as running or biking. Activity levels between Aₘᵢₙ and Aₘₐₓ can include, for example, light walking, moderate walking, and jogging. In preferred implementations, values for Aₘᵢₙ, Aₘₐₓ, M_{A,min}, and/or M_{A,max} can vary from garment to garment and/or can be determined based on user preferences, user settings, and/or machine learning. In the depicted example, the activity multiplier M_{A} varies linearly with activity level between Aₘᵢₙ and Aₘₐₓ; however, other mathematical relationships between the activity multiplier M_{A} and the activity level are possible (e.g., exponential or quadratic).

The logic system 36 can use the relationship between the activity multiplier M_{A} and the activity level to determine how much power P to provide to the heating elements 16. In one example, the logic system 36 can determine the power P using

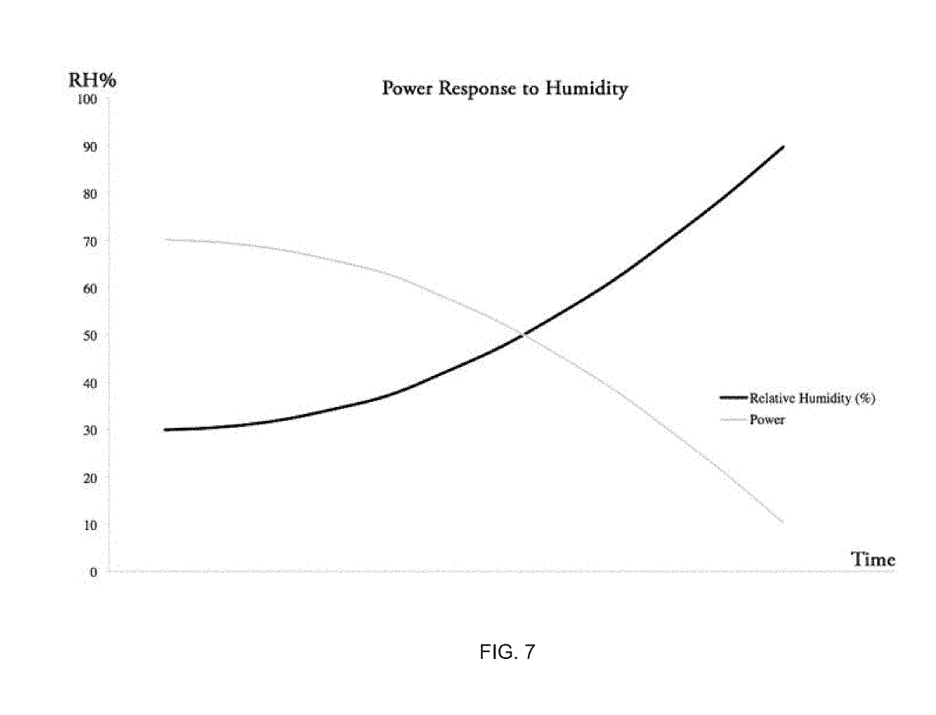

P=P^{init}*M_{A} (2)

where P^{init} is an initial or unadjusted power, for example, determined from a relationship between power and external temperature, as described herein. FIG. 4C includes a table showing example power P values for various combinations of external temperature and activity level, as determined using equation (2). Alternatively or additionally, P^{init} can be determined based on measurements of relative humidity or temperature inside the garment. For example, referring to FIG. 7, relative humidity measurements can be used to calculate power P. In one example, relative humidity can be converted to a relative humidity multiplier, which can be used to adjust power P, similar to how power P is adjusted using activity level and equation (2). Alternatively or additionally, the activity multiplier M_{A} can be adjusted according to relative humidity (e.g., inversely proportional to relative humidity). This can allow the power P to be reduced as the relative humidity between the garment and the wearer's body rises (e.g., due to perspiration).

In certain examples, the logic system 36 can utilize machine learning to determine how to adjust or set power to provide optimal heating or optical internal temperatures (e.g., for a given external temperature and activity level). Measurement data obtained from one or more sensors in the garment 2 can be stored and used to train a predictive model used by the logic system 36. The predictive model can be or include a classifier such as, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests, Gradient Boosting Trees), neural networks, and/or learning vector quantization models. Other classifiers can be used. The classifier can be trained using recorded power levels, user settings, and/or measurement data obtained from sensors in the garment 2 (e.g., temperature sensors, relative humidity sensors, and/or the IMU 34). Once trained, the classifier can receive one or more parameters as input (e.g., measured external temperature, relative humidity, and/or activity level) and provide a power level as output. The classifier can be retrained periodically or continually, as additional training data is acquired.

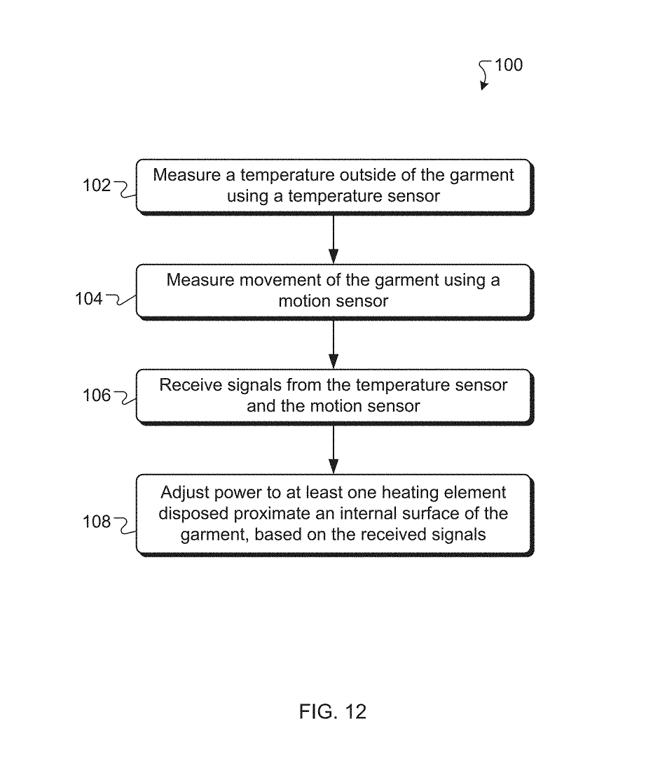

FIG. 12 is a flowchart of an example method 100 of heating a garment. A temperature outside of the garment is measured (step 102) using a temperature sensor. Movement of the garment is measured (step 104) using a motion sensor (an accelerometer). Signals from the temperature sensor and the motion sensor are received (step 106), for example, by a controller. Power is adjusted (step 108) to at least one heating element disposed proximate an internal surface of the garment, based on the received signals.

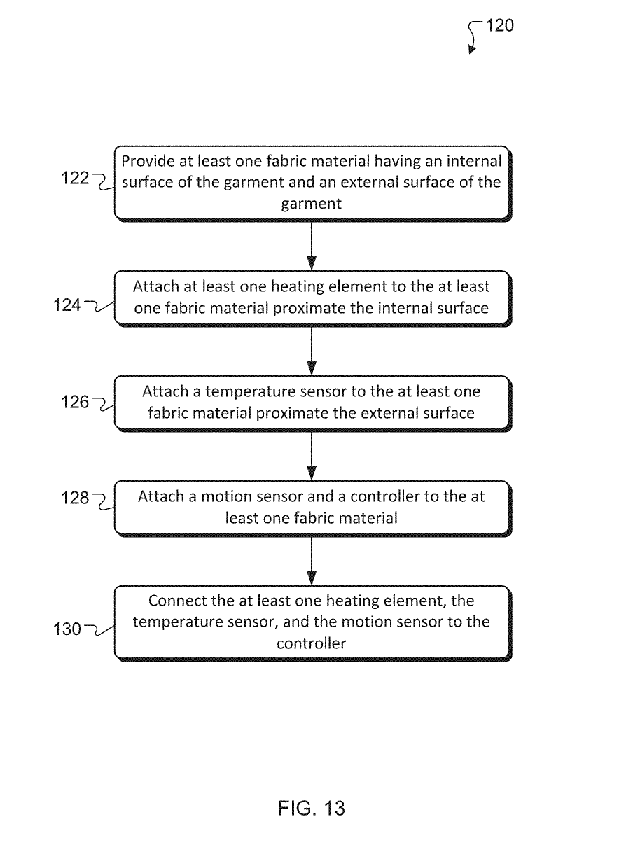

FIG. 13 is a flowchart of an example method 120 of manufacturing a garment. At least one fabric material is provided (step 122) that includes an internal surface of the garment and an external surface of the garment. At least one heating element is attached (step 124) to the at least one fabric material proximate the internal surface. A temperature sensor is attached (step 126) to the at least one fabric material proximate the external surface. A motion sensor and a controller are attached (step 128) to the at least one fabric material. The at least one heating element, the temperature sensor, and the motion sensor are connected (step 130) to the controller. As described herein, the controller is configured to adjust power to the at least one heating element based on signals received from the temperature sensor and/or the motion sensor. In various examples, the at least one heating element, the temperature sensor, the motion sensor, and/or the controller can be attached to the fabric material with an adhesive (e.g., a polyurethane adhesive) and/or with one or more stitches or pieces of thread.

In general, the apparatus, systems, and methods described herein relate to the manufacture and use of an intelligent thermal heating system for a garment or outerwear. The garment can include a body having a front and back, with two fabric materials for outer and inner surfaces, which may be separated by an insulation material. The garment may include sleeves of the same or similar construction. The garment can have a multitude of resistive heating elements, arranged in a winding structure to target heat generation in a certain area. These areas in a jacket can include, for example, a front pocket area near the wearer's hands and a center back area. The heating system can utilize five (5) volt Universal Serial Bus connectors as the primary power source. The power can be distributed from a removable battery stored within a pocketing structure of the garment.

A controller for the heating system can receive direct control and/or preference input from the wearer, the wearer's activity level, and/or the environment. The heating system can include, for example, one or more thermal sensors for measuring internal and external temperature of the garment, accelerometers or inertial measurement unit for measuring motion, humidity sensors for measuring relative humidity, and/or wireless connectivity components (e.g., BLUETOOTH) for user input. Digital and analog inputs from sensors and the wearer's client device can be processed by a microprocessor which can output signals to a power electronics control system, which can include or utilize, for example, MOSFETS. In some instances, the control system can use pulse-wave-modulation (PWM) to translate a digital control signal to an analog signal of voltage output. This can allow power to the resistive heating units to be controlled or adjusted.

Additionally or alternatively, machine learning algorithms can generate power response functions between user preferences, user activity, and environmental data. Control logic can be used to determine an ideal power output based on these functions. The function fidelity can increase with usage and acquired training data, thereby allowing the control unit to learn how to preemptively adjust power output when similar conditions are encountered, with little or no user modulation.

In some instances, the heating system can utilize or include a user input application (or “app”) driven by a mobile device or wearable device. The user input application can allow a user to adjust power settings and heating zones as well as monitor output. Signal processing can occur in the application (e.g., on the mobile device) and/or in a control unit attached to the garment. The application can store data long term for processing on a server and/or in the application or client device itself. Power response functions can be modulated through the application. Data communication between the application and the control unit may occur through a wire or wireless connection (e.g., BLUETOOTH). Additionally or alternatively, the heating system can include voice control capabilities that allow a wearer to interact and control the garment and/or application through an electronic device with a voice user interface or virtual assistant.

Advantageously, the heating system described herein can provide a range of power output with precise power control and is not limited to a number of discrete power levels. The heating system can utilize a wireless electronic device (e.g., a client device) that can process digital inputs, analog inputs such as temperature, moisture and acceleration and through a power-electronics system control output power to the heating system. A system of device firmware and smart device software can be included that enables the wearer to provide preferences for desired heating or power levels in varying environments. Personalized control functions can be developed using machine learning and/or regression models. In some instances, a method of modulating heat output based on motion data and/or relative humidity can reduce the likelihood of overheating. In preferred examples, the control system can learn trigger events that can cause the wearer to interact with the app and/or begin pre-heating the garment based on user preferences. For example, detection of a sudden acceleration can indicate the wearer is putting on the garment before a work commute (e.g., based on time of day) and, in response, pre-heating can be initiated automatically (e.g., without further instructions from the wearer). The heating system and/or the client device can be capable of handling multiple user profiles, such that the heating system can learn unique preference profiles of individual wearers. For example, the heating system can learn a wearer's preferences and/or the wearer's thermal profile and, based thereon, can achieve and maintain the user's desired garment temperatures automatically, with little or no manual intervention from the user. Advantageously, the heating system can extend battery life and use time per charge by applying heat only when needed (e.g., based on user activity and/or temperatures). The software application linked to the heating system can include a graphical user interface that allows user preferences and manual controls to be input by a user of the client device running the software application. The application can be used to update firmware and response formulas and parameters associated with the heating system. The heated garment can be activated by voice control, for example, through Internet-based voice servers and/or interfaces.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A garment, comprising:
at least one heating element disposed proximate an internal surface of the garment;
a temperature sensor configured to measure a temperature outside of the garment;
a motion sensor configured to measure movement of the garment; and
a controller configured to adjust power to the at least one heating element based on signals received from the temperature sensor and the motion sensor.

2. The garment of claim 1, wherein the at least one heating element comprises a resistive heating element.

3. The garment of claim 1, wherein the at least one heating element comprises a first heating element disposed proximate a back side of the garment and a second heating element disposed proximate a front side of the garment.

4. The garment of claim 1, wherein the garment comprises at least one of a jacket, a shirt, a hat, footwear, or pants.

5. The garment of claim 1, wherein the temperature sensor is disposed proximate an exterior surface of the garment.

6. The garment of claim 1, wherein the motion sensor comprises an accelerometer disposed on the garment.

7. The garment of claim 1, wherein the garment comprises a humidity sensor disposed proximate the internal surface of the garment, and wherein the controller is configured to adjust the power based on a signal received from the humidity sensor.

8. The garment of claim 1, wherein the garment comprises a second temperature sensor disposed proximate the internal surface.

9. The garment of claim 8, wherein the controller is configured to control a temperature inside the garment based on a signal received from the second temperature sensor.

10. The garment of claim 1, wherein the controller is configured to adjust the power based on at least one heating preference of a wearer of the garment.

11. A method of heating a garment, comprising:
measuring a temperature outside of the garment using a temperature sensor;
measuring movement of the garment using a motion sensor;
receiving signals from the temperature sensor and the motion sensor; and
adjusting power to at least one heating element disposed proximate an internal surface of the garment, based on the received signals.

12. The method of claim 11, wherein the garment comprises at least one of a jacket, a shirt, a hat, footwear, or pants.

13. The method of claim 11, wherein the temperature sensor is disposed proximate an exterior surface of the garment.

14. The method of claim 11, wherein the motion sensor comprises an accelerometer disposed on the garment.

15. The method of claim 11, wherein the power is adjusted based on a signal received from a humidity sensor disposed proximate the internal surface of the garment.

16. The method of claim 11, wherein adjusting the power comprises using a controller configured for at least one of proportional control, derivative control, integral control, or any combination thereof.

17. The method of claim 11, further comprising:
measuring a temperature inside the garment using a second temperature sensor disposed proximate the internal surface;
receiving a signal from the second temperature sensor; and
controlling the temperature inside the garment based on the signal received from the second temperature sensor.

18. A method of manufacturing a garment, comprising:
providing at least one fabric material comprising an internal surface of the garment and an external surface of the garment;
attaching at least one heating element to the at least one fabric material proximate the internal surface;
attaching a temperature sensor to the at least one fabric material proximate the external surface;
attaching a motion sensor and a controller to the at least one fabric material; and
connecting the at least one heating element, the temperature sensor, and the motion sensor to the controller,
wherein the controller is configured to adjust power to the at least one heating element based on signals received from the temperature sensor and the motion sensor.

19. The method of claim 18, wherein the at least one heating element, the temperature sensor, and the motion sensor are connected to the controller using a plurality of wires.

20. The garment manufactured according to the method of claim 18.
